(19) United States
(12) Patent Application Publication
(10) Pub. No.: US 2003/0044529 A1
(43) Pub. Date: Mar. 6, 2003

(54) Method of depositing thin film

(76) Inventors: Hsiao-Che Wu, Taoyuan Hsien (TW); Champion Yi, Hsinchu Hsien (TW)

Correspondence Address: J.C. Patents, Inc., Suite 250, 4 Venture, Irvine, CA, 92618, US

(21) Appl. No.: 09/967,707

(22) Filed: Sep. 27, 2001

(30) Foreign Application Priority Data
Aug. 29, 2001 (TW) 90121265

(51) Int. Cl. B05D 3/12

(52) U.S. Cl. 427/240

(57) ABSTRACT

A method of depositing a thin film. The method involves rotating deposited species around a normal line of a wafer, wherein an incident direction of the deposited species makes an angle with the normal line of the wafer, so that the deposited species is deposited over the wafer.

### BACKGROUND OF THE INVENTION

1. Field of the Invention

The invention relates to a method of depositing a thin film More particularly, the invention relates to a method of controlling step coverage of the deposited thin film.

2. Description of the Related Art

In the semiconductor deposition process, application of sputtering method has been known for quite a long period of time. Since sputtering method has advantages such as low cost, clean process, simple operation, and easy control, it becomes the most commonly used method to deposit the metal thin film. However, the sputtering method usually suffers from problem of poor step coverage. So, when an opening or trench is filled with the metal material formed by sputtering, formation of void happens easily.

Conventionally, several methods were known to overcome the poor step coverage of the deposited thin film. For example, there are collimator sputtering, long-throw sputtering, and ionized metal plasma sputtering methods.

FIG. 1 is a schematic diagram illustrating a method of depositing thin film using a collimated sputtering in the prior art. To simplify the diagram, only necessary elements are illustrated. Referring to FIG. 1, a wafer holder 104 that carries the wafer 102 is placed in a reaction chamber 100. A sputter target 106 is mounted over the wafer 102, with a collimator 108 is located between the sputter target 106 and the wafer 102. When sputtering takes place, atoms excited from the sputter target 106 would shoot towards the wafer 102. Then, the collimator 108 eliminates the atoms having a larger tilt angle with respect to a surface of the wafer 102, so as to achieve an anisotropic deposition with improved step coverage of the deposited thin film.

FIG. 2 is a schematic diagram illustrating a method of depositing thin film using a long throw sputtering in the prior art. The same elements that appear in both FIGS. 1 and 2 share the same reference numerals. Referring to FIG. 2, as a distance between the sputter 106 and the wafer 102 is increased, those atoms excited from the sputter target 106 having a larger tilt angle would not be able to deposit over the wafer 102. Hence, this improves the perpendicular incident direction of the atoms, so as to produce the anisotropic deposition with improved step coverage of the deposited thin film.

FIG. 3 is a schematic diagram illustrating a method of depositing thin film using a ionized metal plasma sputtering in the prior art. The same elements that appear in both FIGS. 1 and 3 share the same reference numerals. Referring to FIG. 3, a radio frequency (RF) coil 112 is provided between the sputter target 106 and the wafer 102. With an electromagnetic resonance produced by the RF coil 112, a substantial amount of the sputtered metal is ionized to achieve better step coverage for depositing the bottom. However, each of the sputtering methods described above has their drawbacks.

In the collimator sputtering method, only a portion of the sputtered atoms can be utilized, so its sputtering efficiency is low. Also, the atoms to be removed by the collimator would adhere to the collimator. And if a thickness of the deposited material that adheres to the collimator keeps increasing and eventually peels off, the wafer would apparently be contaminated by the particles.

As for the long-throw sputtering method, the same problem of low sputtering efficiency as the collimator sputtering method is anticipated, since only a portion of sputtered atoms can be utilized. This further causes more consumption of the sputter target material, resulting a drop in the production yield. Furthermore, since the holes located at the periphery of the wafer are limited by the incident angles, problem of non-uniform film thickness is created.

On the other hand, even though the ionized metal plasma sputtering method provides better coverage for the bottom, it does not provide good coverage for the sidewalls. Also, it is very difficult to adjust the coverage for the bottom and the sidewalls.

### SUMMARY OF THE INVENTION

The invention provides a method of depositing a thin film, which method enables deposition of thin film with good step coverage on a surface of the wafer having an opening or trench therein.

The invention also provides a method of depositing the thin film, which method ensures good thin film deposition efficiency is achieved while the thin film with good step coverage is formed.

To achieve these and other advantages and in accordance with the purpose of the invention, as embodied and broadly described herein, the invention provides a method of depositing the thin film. The method allows a rotating movement between the incident direction of the deposited species and a normal line of the wafer, wherein an angle is created between an incident direction and the normal line of the wafer, so as to deposit the deposited species on the wafer.

According to the invention described above, the objective of the invention is to allow a rotating movement between the incident direction of the deposited species and the normal line of the wafer, as well as formation of an angle between the incident direction and the normal line of the wafer. Hence, this deposits the deposited species on the wafer. As a result, a uniform thin film with good step coverage is formed over a profile of the opening on the wafer.

Also, a radio frequency (RF) coil is mounted between the wafer and a sputter target material desired for producing the deposited species, so that an ionization ratio of the species to be deposited is increased. Furthermore, the deposited species produced in the reaction chamber is substantially utilized, without leaving a part of the deposited species behind even if a thin film with good step coverage ratio is desired. Accordingly, the invention can yield good deposition efficiency.

Both the foregoing general description and the following detailed description are exemplary and explanatory only and are not restrictive of the invention, as claimed.

### BRIEF DESCRIPTION OF THE DRAWINGS

FIG. 1 is a schematic diagram illustrating a method of depositing thin film using a collimated sputtering in the prior art;

FIG. 2 is a schematic diagram illustrating a method of depositing thin film using a long throw sputtering in the prior art;

FIG. 3 is a schematic diagram illustrating a method of depositing thin film using a ionized metal plasma sputtering in the prior art;

FIG. 4 is a schematic diagram illustrating a method to allow a rotating movement between an incident direction of deposited species and a normal line of the wafer, as well as to create an angle between the incident direction and the normal line of the wafer according to the preferred embodiment of the present invention;

FIG. 5 is a schematic diagram illustrating another method to allow a rotating movement between an incident direction of deposited species and a normal line of the wafer, as well as to create an angle between the incident direction and the normal line of the wafer according to the preferred embodiment of the present invention;

FIG. 6 is a schematic diagram illustrating a method of depositing thin film according to the first embodiment of the present invention; and

FIG. 7 is a schematic diagram illustrating a method of depositing thin film according to the second embodiment of the present invention.

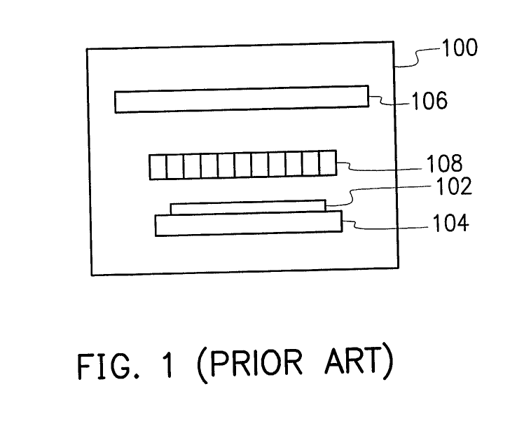

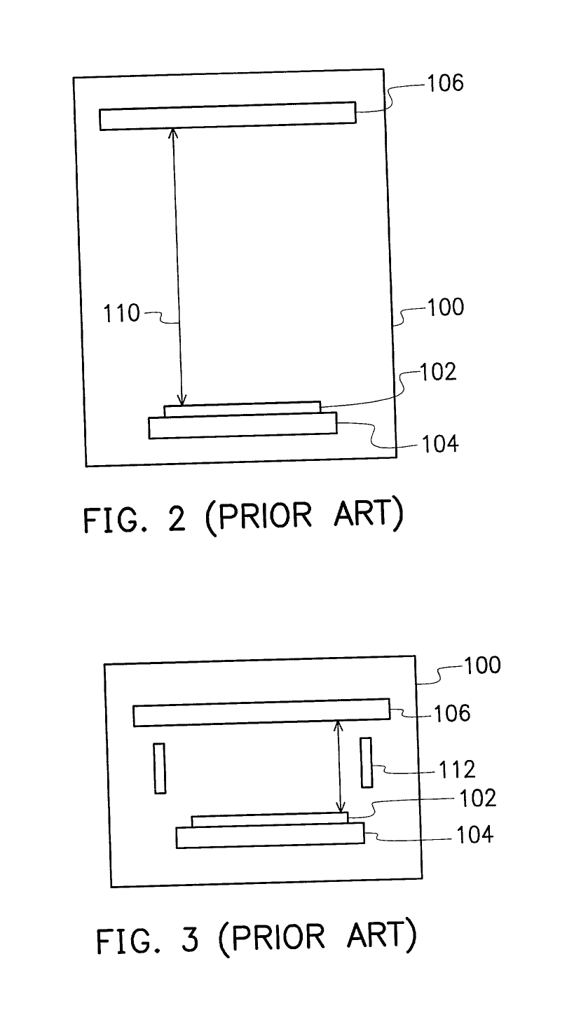

### DESCRIPTION OF THE PREFERRED EMBODIMENTS

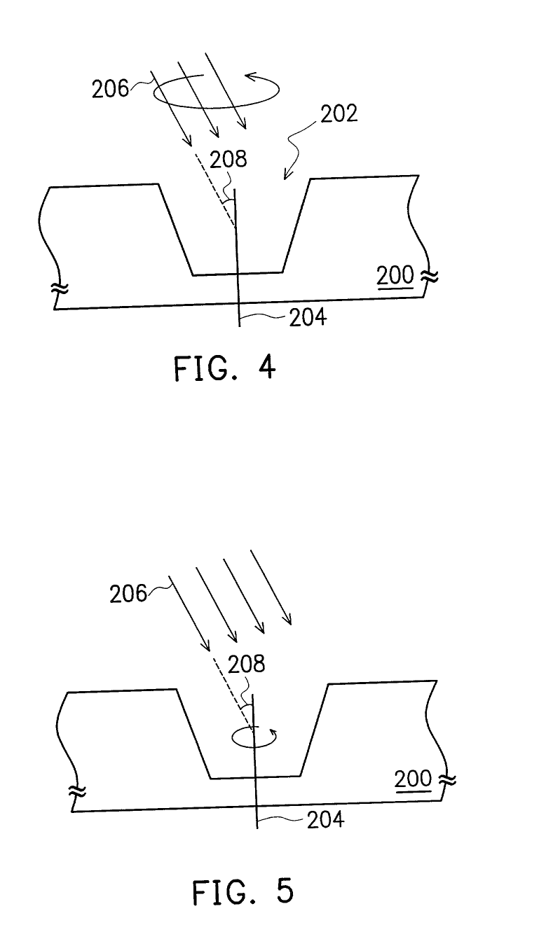

FIGS. 4 and 5 are schematic diagrams illustrating respectively two methods to allow a rotating movement between an incident direction of deposited species and a normal line of the wafer, as well as to create an angle between the incident direction and the normal line of the wafer.

Referring to FIG. 4, a substrate 200 is illustrated with an opening 202 formed thereon. An angle 208 is created between an incident direction 206 of the deposited species and a normal line 204 of the wafer 200. In the meantime, a rotating movement between the incident direction 206 and the wafer 200 is initiated, so as to maintain the angle 208 between the incident direction 206 of the deposited species and the normal line 204 of the wafer 200. And while the wafer 200 is fixed, the incident direction 206 of the deposited species is rotated, with the normal line 204 serving as an axial center.

Referring to FIG. 5, the similar elements that appeared in FIG. 4 are provided with the same reference numerals and the detail description thereof is omitted.

FIG. 5 illustrates a rotating movement between the incident direction 206 and the wafer 200 so as to maintain the angle 208 between the incident direction 206 of the deposited species and the normal line 204 of the wafer 200. And while the wafer 200 is fixed, the incident direction 206 of the deposited species is rotated, with the normal line 204 serving as an axial center.

First Embodiment

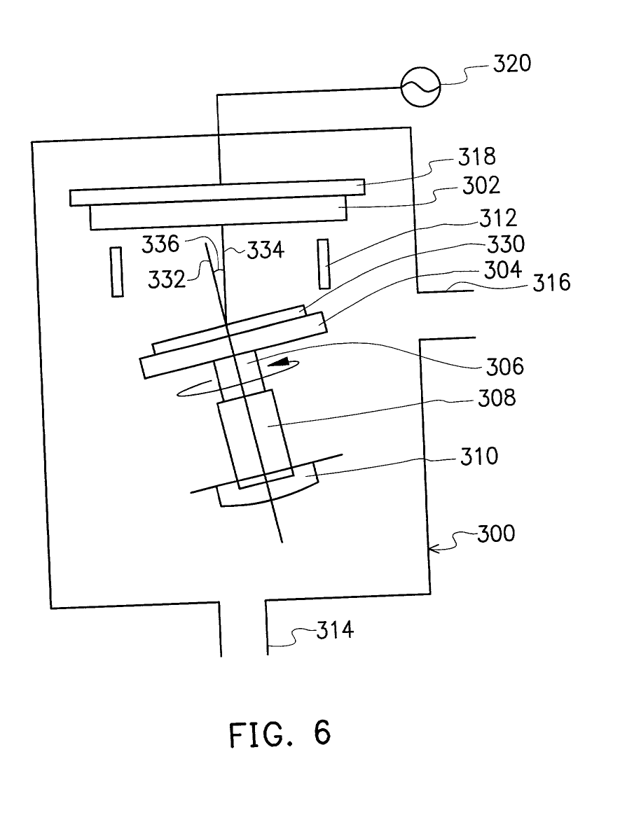

FIG. 6 is a schematic diagram illustrating a method of depositing thin film according to the first embodiment of the present invention As shown in FIG. 6, a sputter target 302 is mounted at top portion of a reaction chamber 300. A wafer holder 304 is then located below the sputter target 302. The wafer holder 304 is connected to a rotating motor 308 through a connecting arm 306, while the rotating motor 308 itself is connected to a mechanical tilting arm 310. Furthermore, a radio frequency (RF) coil 312 is located between the wafer holder 304 and the sputter target 302.

When a deposition step is performed, a wafer 330 is placed on the wafer holder 304 Once the mechanical tilting arm 310 is initiated, a tilt occurs for the wafer holder 304, the connecting arm 306, and the rotating motor 308. As a result, a normal line 332 passing perpendicularly through centers of the wafer 330, the connecting arm 306, and the rotating motor 308 creates an angle 336 with the normal line 334 of the sputter target 302, that is, the incident direction of the deposited species. And the angle 336 depends on a gradient from sidewall of an opening on the wafer 330. For instance, when the gradient is high (or steep), the angle 336 of a small value is adopted. But as the gradient is small, the angle 336 to be adopted has a large value.

Next, air in the reaction chamber 300 is drawn out to nearly vacuum using a vacuum pump (not shown) through a ventilating hole 314 located below the reaction chamber 300. Then an inert gas, such as argon (Ar) is passed into the reaction chamber 300 through a gas inlet 316 located on a sidewall of the reaction chamber 300.

After passing the inert gas into the reaction chamber 300, the rotating motor 308 is initiated while the normal line 322 is fixed. At the same time, the wafer holder 304 and the wafer 330 located thereon are rotated with the normal line 332 serving as an axial center.

A direct current (DC) power supply 320 that connects to an electrode 318 on the sputter target is switched on to bombard the sputter target using the inert gas, so as to produce deposited species. The RF coil 312 is activated using a RF power supply (not shown) to increase an ionization ratio of the deposited species. Then, the deposited species would be deposited to form a thin film over a top surface of the tilting and rotating wafer 330, while the ion components in the deposited species are driven at the same time by the DC power supply 320.

When a deposition step is performed, the wafer 330, the wafer holder 304, the connecting arm 306, and the rotating motor 308 are tilted using a mechanical tilting arm 310. As a result, a normal line 332 that passes through centers of the wafer 330, wafer holder 304, connecting arm 306, and rotating motor 308 creates an angle 336 with the normal line 334 of the sputter target 302. At the same time, the wafer holder 304 and the wafer 330 located thereon are rotated with the normal line 332 serving as an axial center. From the aspect of fixing the wafer 330, this would produce the same result of rotating the incident direction of the deposited species around the normal line 332 of the wafer 330, while creating an angle 336 between the incident direction and the normal line 322. As a result, the thin film formed as described above can cover uniformly over an opening profile on the wafer 330 with excellent step coverage.

Also, the RF coil is located between the sputter target 302 and the wafer holder 304 to improve the ionization ratio of the deposited species. Furthermore, since the deposited species produced by the sputter target 302 can be utilized substantially, a thin film with good step coverage is formed, while yielding a good deposition efficiency in the present invention.

Lastly, the DC power supply 320 and the RF power supply are switched off, while the rotating motor 308 is stopped to end the rotation of the wafer 330. This completes deposition of the thin film.

Second Embodiment

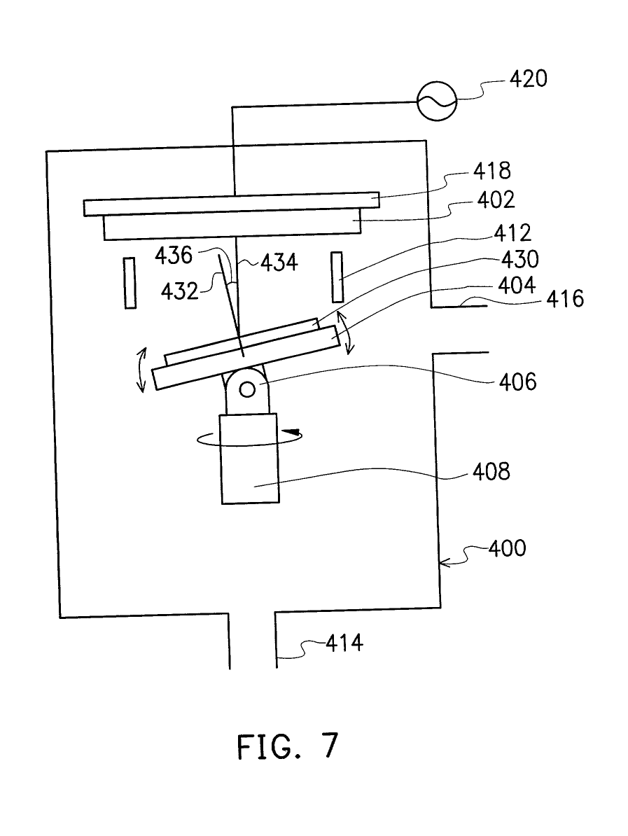

FIG. 7 is a schematic diagram illustrating a method of depositing thin film according to the second embodiment of the present invention.

As shown in FIG. 7, a sputter target 402 is mounted at top portion of a reaction chamber 400. A wafer holder 404 is then located below the sputter target 402. The wafer holder 304 is connected to a mechanical tilting arm 406, while the mechanical tilting arm 406 itself is connected to a rotating motor 408. Furthermore, a radio frequency (RF) coil 412 is located between the wafer holder 404 and the sputter target 402.

When a deposition step is performed, a wafer 430 is placed on the wafer holder 404. Once the mechanical tilting arm 310 is initiated to tilt the wafer holder 404 As a result, a normal line 432 of the wafer 430 creates an angle 436 with the normal line 434 of the sputter target 402, that is, the incident direction of the deposited species. And the angle 436 depends on a gradient from sidewall of an opening on the wafer 430.

Next, air in the reaction chamber 400 is drawn out to nearly vacuum using a vacuum pump (not shown) through a ventilating hole 414 located below the reaction chamber 400. Then an inert gas, such as argon (Ar) is passed into the reaction chamber 400 through a gas inlet 416 located on a sidewall of the reaction chamber 400.

After passing the inert gas into the reaction chamber 400, the rotating motor 408 is initiated while oscillating the wafer holder 404 and the wafer 430 using the mechanical tilting arm 406. When the rotation takes place, the rotating motor rotates with the normal line 432 of the sputter target 402 as an axial center. And when the oscillation of the wafer 430 takes place, the normal line 432 of the wafer 430 oscillates with the normal line 434 of the sputter target as a center, wherein the largest oscillating degree is the angle 436. Therefore, the normal line 432 passing perpendicularly the center of the wafer would rotate and oscillate around the normal line 434 A direct current (DC) power supply 420 that connects to an electrode 418 on the sputter target 402 is switched on to bombard the sputter target 402 using the inert gas, so as to produce deposited species. The RF coil 412 is activated using a RF power supply (not shown) to increase an ionization ratio of the deposited species. Then, the deposited species would be deposited over a top surface of the tilting and rotating wafer 430 to form a thin film, while the ion components in the deposited species are driven at the same time by the DC power supply 420.

When a deposition step is performed, the wafer 430 is tilted to create an angle 436 between the normal line 432 of the wafer 430 and the normal line 434 of the sputter target 402. When the deposition takes places, the wafer 430 is rotated and the normal line 432 is oscillated, so that the normal line 432 rotates and oscillates around the normal line 434. This would produce the same result of rotating the incident direction of the deposited species around the normal line 432 of the wafer 430, while creating an angle 436 between the incident direction and the normal line 432. As a result, the thin film formed as described above can cover uniformly over an opening profile on the wafer 430 with excellent step coverage.

Also, the RF coil 412 is located between the sputter target 402 and the wafer holder 404 to improve the ionization ratio of the deposited species. Also, the deposited species produced by the sputter target 402 can be substantially utilized. Therefore, a thin film with good step coverage is formed, while yielding good deposition efficiency in the present invention.

Lastly, the DC power supply 420 and the RF power supply are switched off, while the rotating motor 408 is stopped to end the rotation of the wafer 430. This completes deposition of the thin film.

It is understood from the first and second embodiments above that the objective of the invention is to tilt and rotate the wafer or rotate and oscillate the normal line of the wafer. The result is equivalent to rotating the deposited species excited from the sputter target around the normal line of the wafer, while an angle between the incident direction of the deposited species and the normal line is created. As a result, the thin film formed as described above can cover uniformly over an opening profile on the wafer with excellent step coverage.

Also, the RF coil is mounted between the wafer and a target material desired for producing the deposited species, so that an ionization ratio of the deposited species is increased. Furthermore, the deposited species produced in the reaction chamber is substantially utilized, without leaving a part of the deposited species behind even if a thin film with good step coverage ratio is desired. Accordingly, the invention can yield good deposition efficiency.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method of depositing a thin film, applicable to a wafer, the method comprising:
providing a source of deposited species; and
rotating the deposited species around a normal line of the wafer, wherein an incident direction of the deposited species makes an angle with the normal line of the wafer, so that the deposited species is deposited over the wafer.

2. The method according to claim 1, wherein the angle depends on a gradient from sidewall of an opening on the wafer.

3. The method according to claim 1, further comprising a radio frequency coil for ionizing the deposited species.

4. The method according to claim 1, wherein the step of rotating the deposited species around a normal line of the wafer comprising steps of:
fixing the angle between the incident direction and normal line; and
rotating the wafer with the normal line as an axial center.

5. The method according to claim 1, wherein the step of rotating the deposited species around a normal line of the wafer comprising steps of:
rotating and oscillating the normal line around the incident direction with the angle being a largest oscillating degree.

6. A method of depositing a thin film, applicable to a wafer, the method comprising:
providing a source of deposited species;
placing the wafer on a wafer holder, wherein the wafer holder is connected to a rotating motor and a mechanical tilting arm;
creating an angle between a normal line that passes through a center of the wafer and an incident direction of the deposited species using the mechanical tilting arm, and
rotating the wafer using the rotating motor, with the normal line as a axial center, so as to deposit the deposited species on the wafer.

7. The method according to claim 6, wherein the angle depends on a gradient from sidewall of an opening on the wafer.

8. The method according to claim 6, further comprising a radio frequency coil for ionizing the deposited species.

9. A method of depositing a thin film, applicable to a wafer, the method comprising:
providing a source of deposited species;
placing the wafer on a wafer holder, wherein the wafer holder is connected to a rotating motor and a mechanical tilting arm; and
rotating the normal line around the incident direction using the rotating motor, and oscillating the normal line using the mechanical tilting arm with the incident direction as a center, wherein a largest oscillating degree being an angle, so as to deposit the deposited species on the wafer.

10. The method according to claim 9, wherein the angle depends on a gradient from sidewall of an opening on the wafer.

11. The method according to claim 9, further comprising a radio frequency coil for ionizing the deposited species.
